(19) United States
(12) Patent Application Publication
(10) Pub. No.: US 2023/0109254 A1
(43) Pub. Date: Apr. 6, 2023

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Minjae KIM, Yongin-si (KR); Jongheon SEOL, Yongin-si (KR); Soochan KIM, Yongin-si (KR); Hyeseung JUNG, Yongin-si (KR); Chaewoong CHO, Yongin-si (KR); Minyoung HONG, Yongin-si (KR); Junghyun NAM, Yongin-si (KR); Sungwoo HAN, Yongin-si (KR)

(21) Appl. No.: 17/938,009

(22) Filed: Oct. 4, 2022

(30) Foreign Application Priority Data
Oct. 5, 2021 (KR) 10-2021-0131916

(51) Int. Cl. H01M 4/38; H01M 10/052; H01M 4/62; H01M 4/04

(52) U.S. Cl. CPC H01M 4/386; H01M 10/052; H01M 4/625; H01M 4/0404; H01M 2004/027

(57) ABSTRACT

A negative electrode for a rechargeable lithium battery and a rechargeable lithium battery including the same are provided herein. The negative electrode includes a current collector and a negative active material layer on the current collector, the negative active material layer including a negative active material and a conductive material, wherein the negative active material is at an angle to the current collector, the negative active material includes a silicon-based active material, the conductive material includes carbon nanotubes, and the negative electrode has an orientation ratio represented by Equation 1 of about 50 to about 100, where Equation 1 provides the following: Orientation ratio=I(110)/I(002). In Equation 1, I(110) is a peak intensity at a (110) plane for an x-ray diffraction analysis (XRD) measured by using a CuKα ray, and I(002) is a peak intensity at a (002) plane for the XRD measured by using the CuKα ray).

### CROSS-REFERENCE TO RELATED APPLICATION

This application claims priority to and the benefit of Korean Patent Application No. 10-2021-0131916 filed in the Korean Intellectual Property Office on Oct. 5, 2021, the entire content of which is herein incorporated by reference.

### BACKGROUND

### 1. Field

Embodiments of the present disclosure relate to a negative electrode for a rechargeable lithium battery and a rechargeable lithium battery including the same.

### 2. Description of the Related Art

Rechargeable lithium batteries have recently drawn attention as power sources for small portable electronic devices. Rechargeable lithium batteries use an organic electrolyte solution as opposed to the alkali aqueous solution used by related art batteries and as a result they have a discharge voltage that may be twice or more than that of related art batteries and also have a high energy density.

For positive active materials of rechargeable lithium batteries, one or more suitable lithium-transition metal oxides having a structure capable of intercalating/deintercalating lithium ions, such as LiCoO₂, LiMn₂O₄, LiNi₁₋ₓCoₓO₂ (0<x<1), and/or the like have been utilized.

For negative active materials, one or more suitable carbon-based materials capable of intercalating/deintercalating lithium ions such as artificial graphite, natural graphite, hard carbon, and/or the like have been utilized. Recently, non-carbon-based negative active materials such as silicon or tin have been researched in order to obtain high capacity.

The above information disclosed in this Background section is only for enhancement of understanding of the background of the present disclosure, and therefore it may contain information that does not form the prior art that is already known in this country to a person of ordinary skill in the art.

### SUMMARY

Aspects of one or more embodiments are directed towards a negative electrode for a rechargeable lithium battery exhibiting high energy density and excellent or suitable cycle-life characteristics.

Additional aspects will be set forth in part in the description which follows and, in part, will be apparent from the description, or may be learned by practice of the presented embodiments of the disclosure.

One or more embodiments provide a rechargeable lithium battery including the negative electrode.

One or more embodiments of the present disclosure provide a negative electrode for a rechargeable lithium battery including a current collector and a negative active material layer on the current collector, the negative active material layer including a negative active material and a conductive material, wherein the negative active material is at an angle to the current collector, the negative active material include a silicon-based active material, the conductive material includes carbon nanotubes, and the negative electrode has an orientation ratio represented by Equation 1 of about 50 to about 100.

Equation 1 provides that:

Orientation ratio=I(110)/I(002)

wherein, in Equation 1, I(110) is a peak intensity at a (110) plane for an x-ray diffraction analysis (XRD) measured by utilizing a CuKα ray, and I(002) is a peak intensity at a (002) plane for the XRD measured by utilizing the CuKα ray).

In one or more embodiments, the orientation ratio may be about 54 to about 95.

In one or more embodiments, the silicon-based active material may be a silicon-carbon composite including crystalline carbon, silicon particles, and an amorphous carbon.

In one or more embodiments, the conductive material may be multi-walled carbon nanotubes, single-walled carbon nanotubes, or a combination thereof.

In one or more embodiments, the carbon nanotubes may have an average length of about 1 μm to about 10 μm.

In one or more embodiments, the carbon nanotubes may have an average diameter of about 1 nm to about 5 nm.

In one or more embodiments, the peak intensity may be a peak integral area value.

One or more embodiments of the present disclosure provide a rechargeable lithium battery including the negative electrode, a positive electrode, and an electrolyte.

The above embodiments and additional embodiments are further described in the following detailed description.

An electrode assembly for a rechargeable lithium battery may provide an economical rechargeable lithium battery with low battery resistance.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, serve to explain principles of the present disclosure. In the drawings:

FIG. 1 is a schematic view showing an orientation of a negative electrode relative to a current collector according to one or more embodiments of the present disclosure.

FIG. 2 is an exploded perspective view of a rechargeable lithium battery according to one or more embodiments of the present disclosure.

FIG. 3 is a graph showing capacity retention of half-cells according to Example 1 and Comparative Example 1.

### DETAILED DESCRIPTION

The present disclosure may be modified in many alternate forms, and thus specific embodiments will be illustrated in the drawings and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

Unless otherwise defined in the specification, average particle diameter D50 means the diameter of particles having a cumulative volume of 50 volume % in the particle size distribution and may be measured by a PSA (particle size analyzer). Also, when particles are spherical, “diameter” indicates a spherical particle diameter or an average particle diameter, and when the particles are non-spherical, the “diameter” indicates a major axis length or an average major axis length.

In the specification, “upper” and “lower” are defined based on the drawings, and “upper” may be changed to “lower” and “lower” may be changed to “upper” depending on the point of view. What is referred to as “on” or “above” may include the situation where other structures are interposed in the middle as well as directly above. It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

A negative electrode for a rechargeable lithium battery includes a current collector and a negative active material layer formed on the current collector, and the negative active material layer includes a negative active material and a conductive material. In one or more embodiments, the negative active material includes a silicon-based active material and the conductive material includes carbon nanotubes.

The negative active material is oriented to the current collector with a set or predetermined angle.

The negative electrode may have an orientation ratio represented by Equation 1 of about 50 to about 100, and according to one or more embodiments, about 54 to about 95.

Orientation ratio=I(110)/I(002) Equation 1

In Equation 1,

I(110) is a peak intensity at a (110) plane when XRD is measured by utilizing a CuKα ray, and

I(002) is a peak intensity at a (002) plane when x-ray diffraction analysis (XRD) is measured by utilizing a CuKα ray. Generally, the peak intensity indicates a height of a peak or an integral area of the peak, and according to one or more embodiments, the peak intensity indicates the integral area of a peak.

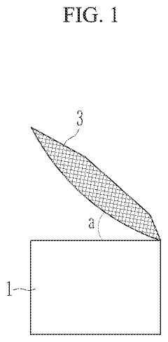

In the embodiment, the orientation ratio of the negative electrode having the above range indicates that the negative active material 3 is oriented to the current collector 1 with a set or predetermined angle (a), as shown in FIG. 1.

For example, the negative active material is not in the form of lying horizontally and parallel to the current collector and is positioned in or at a standing state at a set or predetermined angle to the current collector. When the orientation ratio is within the range, a resistance to transferring electrolyte in the negative electrode may be reduced and lithium ions may be readily transferred during charge and discharge. Thus, the effect of actively transferring lithium around the active material may be effectively obtained in embodiments utilizing the silicon-based active material, rather than a carbon-based active material.

In one or more embodiments, the XRD is measured by utilizing a CuKα ray as a target ray, and is measured for the prepared negative electrode. In one or more embodiments, the XRD value may be the same value (e.g., substantially the same value) as the measurement for the battery which is fabricated utilizing the negative electrode, before performing formation charging and discharging.

The XRD is measured by removing a monochromator in order to improve a peak intensity resolution. In one or more embodiments, the measurement condition may include an angle 2θ of about 20° to about 80°, a scan speed (°/S) of about 0.044 to about 0.089, and a step size (°/step) of about 0.013 to about 0.039.

When the orientation ratio is out of the range, for example, more than about 100, the resistance for moving the electrolyte in the negative electrode during charge and discharge is increased, thereby increasing battery resistance, and, when it is less than about 50, the compression may not be satisfied (may not be suitable), thereby reducing energy density of the battery.

The orientation ratio of the negative electrode in embodiments of the present disclosure is significantly lower than about 300 to about 500, which is the ratio obtained when a magnetic field is not applied.

The effect of reducing resistance that is caused by the smooth occurrence of lithium ions (e.g., the ready transference of lithium ions around the negative electrode) may be more effectively obtained when the silicon-based active material is utilized.

This is because the specific capacity (capacity per weight) of silicon is higher than graphite so that many lithium ions are required or may be transferred, and thus the effect of reducing resistance is greater. In one or more embodiments, the silicon-based active material has volume expansion and a larger utilized amount per weight (mAh/g) during charge and discharge, when compared to the carbon-based active material, thereby effectively reducing the resistance for transferring lithium ions. Thus improved transference of lithium ions may be effectively obtained by adopting the silicon-based active material, rather than the carbon-based active material.

The silicon-based active material may be crystalline or a silicon-carbon composite including carbon, silicon, and an amorphous carbon. For example, the silicon-based active material may be a silicon-carbon composite including a core including a crystalline carbon and silicon and an amorphous carbon coating layer surrounded on the core. In one or more embodiments, the silicon-based active material may be a silicon-carbon composite including an agglomerated product in which crystalline carbon and silicon are agglomerated, and an amorphous carbon is positioned between the agglomerated product or on a surface of the agglomerated product.

The amorphous carbon may be soft carbon, hard carbon, mesophase pitch carbide, sintered cokes, or a combination thereof. The crystalline carbon may be natural graphite, artificial graphite, or a combination thereof.

In the silicon-carbon composite, an amount of silicon may be about 1 wt % to about 60 wt % of the total, where the total is 100 wt % of the silicon-carbon composite, or according to one or more embodiments, about 3 wt % to about 60 wt %. Furthermore, in silicon-carbon composite, an amount of the amorphous carbon may be about 20 wt % to about 60 wt % of the total, where the total is 100 wt % of the silicon-carbon composite, and an amount of the crystalline carbon may be about 20 wt % to about 60 wt % of the total, where the total is 100 wt % of the silicon-carbon composite.

The negative electrode having the orientation ratio may be prepared by coating a negative active material composition for preparing a negative active material layer and passing it through a magnetic field. As described in more detail below, the negative active material composition including the negative active material and a conductive material is coated on the current collector, passed through magnetism, e.g., an area where the magnetic field is generated, dried, and pressed to prepare a negative active material layer.

Passing the negative active material through the area where the magnetic field is generated produces magnetic flux by a magnet in a vertical direction, but because the magnetic field, based on a coating speed (a speed of movement of the current collector) is formed at a set or predetermined angle as a vector function, “orientation” occurs, which may cause the negative active material to stand at the set or predetermined angle on the current collector.

The area where the magnetic field is generated may be formed by arranging a magnet to be positioned to have a set or predetermined distance from the active material layer, and in one or more embodiments, the area may be an area in which the strength of the magnetic field measured on a surface of the active material layer may be about 2000 Gauss to about 5000 Gauss.

In one or more embodiments, the strength of the magnetic field may be about 3000 Gauss to about 4000 Gauss. Furthermore, the speed for passing through the area where the magnetic field is generated may be about 3.0 m/min to about 5.0 m/min.

The negative active material layer composition may have a viscosity of about 500 cps to about 5000 cps, or about 1000 cps to 4000 cps, at room temperature (about 20° C. to about 25° C.). When the viscosity of the composition is within this range, a suitable orientation angle during the application of the magnetic field may be effectively obtained.

When the strength of the magnetic field and the time for exposing the magnetic field are within the above ranges, the orientation ratio of the negative electrode obtained may be about 50 to about 100, and according to one or more embodiments, may be about 54 to about 94. When the strength of the magnetic field or the time for exposing the magnetic field is out of the range, the resulting orientation degree of the negative electrode may not be in the above ranges and may not be desirable or suitable.

In one or more embodiments, the conductive material may be carbon nanotubes, and in one or more embodiments, the carbon nanotubes may be single-walled carbon nanotubes, multi-walled carbon nanotubes, or a combination thereof.

The inclusion of carbon nanotubes as a conductive material allows the distribution of the conductive material on a surface of the silicon-based active material, and in one or more embodiments, a surface of silicon may help the formation of an electrical network, and maintain excellent or suitable electrical conductivity under the volume expansion/shrinkage during charge and discharge, thereby improving the cycle-life characteristics. Such an effect may not be obtained by utilizing particle-shaped conductive materials. Furthermore, such an effect may not be obtained by utilizing linear conductive materials having high straightness, such as carbon nanofiber (CNF), as it may insufficiently cover the surface of the active material.

The carbon nanotubes may have an average length of about 1 μm to about 10 μm. For example, the average length may be about 1 μm to about 6 μm. The carbon nanotubes may have a diameter of about 1 nm to about 5 nm. When the average length or the average diameter of carbon nanotubes is in the range, straightness is low (e.g., there is good or suitable bending), and even when carbon nanotubes are utilized at a small amount, it may be effectively distributed on the surface of the active material.

In one or more embodiments, the negative active material layer may further include a carbon-based active material together with the silicon-based active material. The carbon-based negative active material may be crystalline carbon or amorphous carbon, or both may be utilized therewith. The crystalline carbon may be unspecified shaped, sheet-shaped, flake-shaped, spherically-shaped, or fiber-shaped natural graphite or artificial graphite. The amorphous carbon may be soft carbon, hard carbon, mesophase pitch carbide, sintered cokes, and/or the like.

When the negative active material layer includes both the silicon-based active material and the carbon-based active material, the mixing ratio of the silicon-based active material and the carbon-based active material may be about 99:1 to about 1:99 by weight ratio. The negative active material layer may further include a binder.

In the negative active material layer, an amount of the conductive material may be about 0.01 wt % to about 5 wt %, about 0.01 wt % to about 3 wt %, about 0.01 wt % to about 2 wt %, about 0.01 wt % to about 1 wt %, or about 0.01 wt % to about 0.5 wt % based on the total of the negative active material layer.

An amount of the negative active material may be about 90 wt % to 98.99 wt %, and an amount of the binder may be about 1 wt % to about 5 wt % based on the total, 100 wt %, of the negative active material layer.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinylfluoride, polyurethane, polytetrafluoro ethylene, polyvinylidene fluoride, polyethylene, polypropylene, polyamide imide, polyimide, or a combination thereof.

The aqueous binder may be a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polypropylene, polyepichlorohydrin, polyphosphazene, an ethylene propylene diene copolymer, polyvinylpyridine, chlorosulfonated polyethylene, latex, polyester resin, an acrylic resin, a phenolic resin, an epoxy resin, polyvinyl alcohol, or a combination thereof.

When the aqueous binder is utilized as a negative electrode binder, a cellulose-based compound may be further utilized to provide viscosity as a thickener. The cellulose-based compound includes one or more of carboxymethyl cellulose, hydroxypropyl methylcellulose, methyl cellulose, and/or alkali metal salts thereof. The alkali metal may be Na, K, or Li. The thickener may be included in an amount of about 0.1 parts by weight to about 3 parts by weight based on 100 parts by weight of the negative active material.

The current collector may include (e.g., may include one selected from) a copper foil, a nickel foil, a stainless steel foil, a titanium foil, a nickel foam, a copper foam, a polymer substrate coated with a conductive metal, and/or a combination thereof, but the present disclosure is not limited thereto.

A rechargeable lithium battery according to one or more embodiments includes the negative electrode, a positive electrode, and an electrolyte.

The positive electrode may include a current collector and a positive active material layer formed on the current collector. The positive electrode active material may include lithiated intercalation compounds that reversibly intercalate and deintercalate lithium ions. For example, one or more composite oxides of a metal including (e.g., selected from) cobalt, manganese, nickel, and/or a combination thereof, and lithium may be utilized. More specifically, the compounds represented by one of the following chemical formulae may be utilized: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}Dₐ (0.90≤a≤1.8, 0≤b≤0.5, 0≤c≤0.5, 0<α<2); LiₐNi_{1-b-c}CO_{b}X_{c}O_{2-αTα} (0.90≤a≤1.8, 0≤b≤0.5, 0≤c≤0.05, 0<α<2); LiₐNi_{1-b-c}CO_{b}X_{c}O₂₋ₐT₂ (0.90≤a≤1.8, 0≤b≤0.5, 0≤c≤0.5, 0<α<2); LiₐNi_{1-b-c}Mn_{b}X_{c}Dₐ(0.90≤a≤1.8, 0≤b≤0.5, 0≤c≤0.5, 0<α≤2); LiₐNi_{1-b-c}Mn_{b}X_{c}O_{2-αTα} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂PO₄₃ (0≤f≤2); Li_{(3-f)}Fe₂PO₄₃ (0≤f≤2); and/or LiₐFePO₄ (0.90≤a≤1.8).

In the above chemical formulae, A includes (e.g., is selected from) Ni, Co, Mn, and/or a combination thereof; X includes (e.g., is selected from) Al, Ni, Co, Mn, Cr, Fe, Mg, Sr, V, a rare earth element, and/or a combination thereof; D includes (e.g., is selected from) O, F, S, P, and/or a combination thereof; E includes (e.g., is selected from) Co, Mn, and/or a combination thereof; T includes (e.g., is selected from) F, S, P, and/or a combination thereof; G includes (e.g., is selected from) Al, Cr, Mn, Fe, Mg, La, Ce, Sr, V, and/or a combination thereof; Q includes (e.g., is selected from) Ti, Mo, Mn, and a combination thereof; Z includes (e.g., is selected from) Cr, V, Fe, Sc, Y, and/or a combination thereof; and J includes (e.g., is selected from) V, Cr, Mn, Co, Ni, Cu, and/or a combination thereof.

Also, the compounds may have a coating layer on the surface, or may be mixed with another compound having a coating layer. The coating layer may include at least one coating element compound of (e.g., selected from the group consisting of) an oxide of a coating element, a hydroxide of a coating element, an oxyhydroxide of a coating element, an oxycarbonate of a coating element, and/or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by utilizing these elements in the compound, and for example, the method may include any coating method such as spray coating, dipping, and/or any other suitable method, but is not described in more detail as it is well-known in the related field.

In the positive electrode, an amount of the positive active material may be about 90 wt % to about 98 wt % based on the total weight of the positive active material layer.

In one or more embodiments of the present disclosure, the positive active material layer may further include a binder and a conductive material. In one or more embodiments, the binder and the conductive material may be included in an amount of about 1 wt % to about 5 wt %, respectively, based on the total amount of the positive active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and/or the like, but the present disclosure is not limited thereto.

The conductive material is included to provide electrode conductivity (e.g., is a conductor), and any electrically conductive material may be utilized as a conductive material unless it causes a chemical change. Examples of the conductive material include a carbon-based material such as natural graphite, artificial graphite, carbon black, acetylene black, ketjen black, a carbon fiber, and/or the any other suitable carbon-based material; a metal-based material of a metal powder or a metal fiber including copper, nickel, aluminum, silver, and/or any other suitable metal-based material; a conductive polymer such as a polyphenylene derivative; or a mixture thereof.

The current collector may utilize aluminum foil, nickel foil, or a combination thereof, but the present disclosure is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or any other suitable carbonate-based solvent. The ester-based solvent may include methyl acetate, ethyl acetate, n-propyl acetate, dimethyl acetate, methyl propionate, ethyl propionate, propyl propionate decanolide, mevalonolactone, caprolactone, and/or any other suitable ester-based solvent. The ether-based solvent may include dibutyl ether, tetraglyme, diglyme, dimethoxyethane, 2-methyltetrahydrofuran, tetrahydrofuran, and/or any other suitable ether-based solvent. Furthermore, the ketone-based solvent may include cyclohexanone, and/or any other suitable ketone-based solvent. The alcohol-based solvent may include ethyl alcohol, isopropyl alcohol, and/or any other suitable alcohol-based solvent, and examples of the aprotic solvent include nitriles such as R—CN (where R is a C2 to C20 linear, branched, or cyclic hydrocarbon, and may include a double bond, an aromatic ring, and/or an ether bond), amides such as dimethylformamide, dioxolanes such as 1,3-dioxolane, sulfolanes, and/or any other suitable aprotic solvent.

The organic solvent may be utilized alone or in a mixture. When the organic solvent is utilized in a mixture, the mixture ratio may be controlled or selected in accordance with a desirable battery performance as may be well known to one of skill in the related art.

Furthermore, the carbonate-based solvent may desirably include a mixture with a cyclic carbonate and a linear carbonate. The cyclic carbonate and linear carbonate are mixed together in a volume ratio of about 1:1 to about 1:9, and when the mixture is utilized as an electrolyte, it may have enhanced performance.

The organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

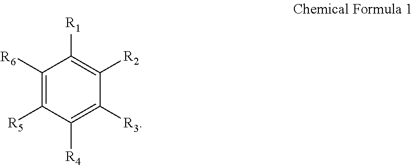

In Chemical Formula 1, R₁ to R₆ may each independently be the same or different and may include (e.g., are selected from) hydrogen, a halogen, a C1 to C10 alkyl group, a haloalkyl group, and/or a combination thereof.

Specific examples of the aromatic hydrocarbon-based organic solvent may include (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include vinylene carbonate, an ethylene carbonate-based compound represented by Chemical Formula 2, as an additive for improving cycle life.

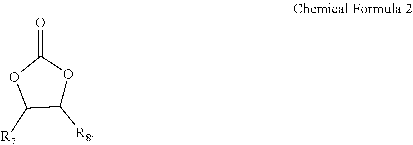

In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not concurrently (e.g., simultaneously) hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. An amount of the additive for improving the cycle-life characteristics may be utilized within an appropriate or suitable range.

The non-aqueous organic solvent may also include vinylethylene carbonate, hexane tricyanide, lithium tetrafluoroborate, propane sultone, etc., as an additive.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salts of (e.g., selected from) LiPF₆, LiBF₄, LiSbF₆, LiAsF₆, LiN (SO₂C₂F₅)₂, Li (CF₃SO₂)₂N, LiN (SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein, x and y are natural numbers, for example, an integer of 1 to 20, lithium difluoro(bisoxolato) phosphate), LiCl, Lil, LiB(C₂O₄)₂ (lithium bis(oxalato) borate: LiBOB) and/or lithium difluoro(oxalato)borate (LiDFOB). A concentration of the lithium salt may range from about 0.1 M to about 2.0 M. When the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

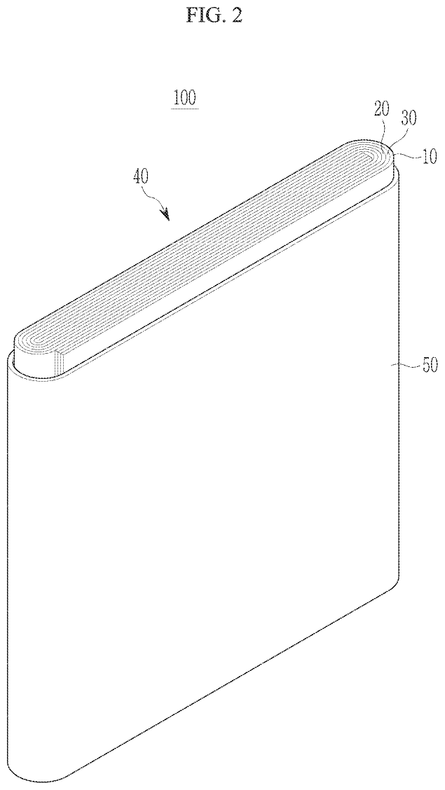

FIG. 2 is an exploded perspective view of a rechargeable lithium battery according to one or more embodiments of the present disclosure. The rechargeable lithium battery according to one or more embodiments is illustrated as a prismatic battery, but the present disclosure is not limited thereto and may include variously-shaped batteries such as a cylindrical battery, a pouch battery, and/or the like.

Referring to FIG. 2, a rechargeable lithium battery 100 according to one or more embodiments may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Example 1

97.45 wt % of a silicon-carbon composite negative active material, 0.05 wt % of single-walled carbon nanotubes (SWCNT, average length: 5 μm, average diameter: 1.5 nm), 1.5 wt % of styrene butadiene rubber, and 1.0 wt % of carboxymethyl cellulose were mixed in a water solvent to prepare a slurry for a negative active material layer having a viscosity of 1830 cps (at 25° C.).

The silicon-carbon composite including a core including artificial graphite and silicon nanoparticles, and a soft carbon coating layer formed on the surface of the core, was utilized. Herein, an amount of artificial graphite was 40 wt %, an amount of the silicon nanoparticles was 40 wt %, and an amount of the amorphous carbon was 20 wt % based on the total weight of the silicon-carbon composite.

The slurry for a negative active material layer was coated on a Cu foil and the coated Cu foil was moved to pass through an area where the magnetic field was generated at a rate of a 4.0 m/min. In the area where the magnetic field was generated, the magnet was positioned to have a set or predetermined gap from the Cu foil, and the magnetic field generated by the magnet in the area was 3500 Gauss on the surface of the Cu foil.

Thereafter, the obtained product was dried and pressed to produce a negative electrode.

96 wt % of LiCoO₂, 2 wt % of ketjen black, and 2 wt % of polyvinylidene fluoride were mixed in an N-methyl pyrrolidone solvent to prepare a positive active material slurry. The positive active material slurry was coated on an Al current collector and dried followed by pressing to prepare a positive electrode.

Using the negative electrode, a polyethylene/polypropylene separator, the positive electrode, and an electrolyte solution, a rechargeable lithium cell battery was fabricated by the general procedure. The electrolyte was prepared by utilizing a mixed solvent of ethylene carbonate and diethyl carbonate (50:50 volume ratio) and dissolving 1 M LiPF₆ therein.

### Example 2

A negative electrode and a rechargeable lithium cell were fabricated by the same procedure as in Example 1, except that the magnetic field generated by the magnet was controlled or selected to have 3000 Gauss.

### Example 3

A negative electrode and a rechargeable lithium cell were fabricated by the same procedure as in Example 1, except that the magnetic field generated by the magnet was controlled or selected to have 4000 Gauss.

### Example 4

A negative electrode and a rechargeable lithium cell were fabricated by the same procedure as in Example 1, except that 97.47 wt % of the silicon-carbon composite negative active material, 0.03 wt % of single-walled carbon nanotubes (average length: 5 μm, average diameter: 1.5 nm), 1.5 wt % of styrene butadiene rubber, and 1 wt % of carboxymethyl cellulose were mixed in a water solvent to prepare a slurry for a negative active material layer having 1720 cps (at 25° C.), and the slurry for the negative active material layer was utilized.

### Example 5

A negative electrode and a rechargeable lithium cell were fabricated by the same procedure as in Example 1, except that 97.4 wt % of the silicon-carbon composite negative active material, 0.1 wt % of multi-walled carbon nanotube (average length: 5 μm, average diameter: 1.5 nm), 1.5 wt % of styrene butadiene rubber, and 1 wt % of carboxymethyl cellulose were mixed in an water solvent to prepare a slurry for a negative active material layer having 1910 cps (at 25° C.), and the slurry for the negative active material layer was utilized.

### Comparative Example 1

A negative electrode and a rechargeable lithium cell were fabricated by the same procedure as in Example 1, except that 97 wt % of the silicon-carbon composite negative active material, 0.5 wt % of ketjen black, 1.5 wt % of styrene butadiene rubber, and 1 wt % of carboxymethyl cellulose were mixed in an water solvent to prepare a slurry for a negative active material layer having 1790 cps (at 25° C.), and the slurry for the negative active material layer was utilized.

### Comparative Example 2

A negative electrode and a rechargeable lithium cell were fabricated by the same procedure as in Example 1, except that 97.45 wt % of the silicon-carbon composite negative active material, 0.05 wt % of single-walled carbon nanotubes (average length: 5 μm, average diameter: 1.5 nm), 1.5 wt % of styrene butadiene rubber, and 1 wt % of carboxymethyl cellulose were mixed in an water solvent to prepare a slurry for a negative active material layer having 1680 cps (at 25° C.), and the slurry for the negative active material layer was utilized.

### Comparative Example 3

A negative electrode and a rechargeable lithium cell were fabricated by the same procedure as in Comparative Example 1, except that the magnetic field generated by the magnet was controlled or selected to have 1000 Gauss.

### Comparative Example 4

A negative electrode and a rechargeable lithium cell were fabricated by the same procedure as in Comparative Example 1, except that the magnetic field generated by the magnet was controlled or selected to have 8000 Gauss.

### Comparative Example 5

97 wt % of an artificial graphite negative active material, 0.1 wt % of single-walled carbon nanotubes (average length: 5 μm, average diameter: 1.5 nm), 1.5 wt % of styrene butadiene rubber, and 1.0 wt % of carboxymethyl cellulose were mixed in an water solvent to prepare a slurry for a negative active material layer having a viscosity of 1900 cps (at 25° C.).

The slurry for the negative active material layer was coated on a Cu foil and dried followed by pressing a negative electrode.

A rechargeable lithium cell was fabricated by the same procedure as in Example 1, except that the negative electrode described herein was utilized.

The amounts of the active material and the conductive material, the type or kind of the conductive material, the strength of the magnetic field, and the viscosity of the slurry are summarized in Table 1.

TABLE 1

| | Active | Conductive | Strength of magnetic | Viscosity |
|---|---|---|---|---|
| | material (wt %) | material (wt %) | field (Gauss) | (cps, at 25° C.) |
| Example 1 | silicon-carbon composite 97.45 | SWCNT 0.05 | 3500 | 1830 |
| Example 2 | silicon-carbon composite 97.45 | SWCNT 0.05 | 3000 | 1830 |
| Example 3 | silicon-carbon composite 97.45 | SWCNT 0.05 | 4000 | 1830 |
| Example 4 | silicon-carbon composite 97.47 | SWCNT 0.03 | 3500 | 1720 |
| Example 5 | silicon-carbon composite 97.4 | SWCNT 0.1 | 3500 | 1910 |
| Comparative | silicon-carbon composite 97 | Ketjen black 0.5 | 3500 | 1790 |
| Example 1 | | | | |
| Comparative | artificial graphite 97.45 | SWCNT 0.05 | 3500 | 1680 |
| Example 2 | | | | |
| Comparative | silicon-carbon composite 97 | Ketjen black 0.5 | 1000 | 1790 |
| Example 3 | | | | |
| Comparative | silicon-carbon composite 97 | Ketjen black 0.5 | 8000 | 1790 |
| Example 4 | | | | |
| Comparative | artificial graphite 97.4 | SWCNT 0.1 | 3500 | 1900 |
| Example 5 | | | | |

### Experimental Example 1) Measurement of Orientation Ratio

The orientation ratio for the negative electrodes according to Examples 1 to 5 and Comparative Examples 1 to 5 were measured. As for the negative electrodes, X′Pert (PANalytical B.V.) XRD equipment utilizing a CuKα ray as a target ray was utilized, but monochromator equipment was removed in order to improve a peak intensity resolution. Herein, the measurement was performed under a condition of 26=20° to 80°, a scan speed (°/S)=0.06436, and a step size of 0.026°/step.

The measured XRD results are shown in Table 2. The results are shown by measuring an area of peak occurring at 26=26.5±0.2° (002 plane) and 77.5±0.2° (110 plane).

From these results, an orientation ratio (I(110)/I(002)) was calculated. The results are shown in Table 2.

### Experimental Example 2) Measurement of Resistance

The specific resistances (resistance value passing in the vertical direction of the negative electrode) for the negative electrodes according to Examples 1 to 5 and Comparative Examples 1 to 5 were measured. The results are shown in Table 2.

Furthermore, the active mass resistance and the interfacial resistance of the negative active material layer according to Examples 1 to 5 and Comparative Examples 1 to 5 were measured utilizing an electrode resistance meter (Hioki Ltd., in-plane). The results are shown in Table 2. The active mass refers to an active material layer.

The specific resistance indicates applied electric current resistance, the active mass resistance indicates volume resistance, and the interfacial resistance indicates a contact resistance between the negative active material layer and the current collector.

TABLE 2

| | | | | Resistance | | |
|---|---|---|---|---|---|---|
| | Orientation ratio | | | Specific | Active mass | Interfacial |
| | | | Orientation | resistance | resistance | resistance |
| | I(110) | I(002) | ratio | (Ωm) | (Ωcm) | (Ωcm²) |
| Comparative | 33170.19 | 477.575 | 69.45344 | 0.29 | 0.0421 | 0.0267 |
| Example 1 | | | | | | |
| Comparative | 77246.4 | 940.532 | 82.13059 | 0.28 | 0.0441 | 0.0231 |
| Example 2 | | | | | | |
| Comparative | 75125.14 | 213.147 | 352.45613 | 0.29 | 0.0399 | 0.0251 |
| Example 3 | | | | | | |
| Comparative | 18291.18 | 600.142 | 30.41312 | 0.29 | 0.0411 | 0.0381 |
| Example 4 | | | | | | |
| Comparative | 68299.24 | 923.862 | 73.92800 | 0.27 | 0.0383 | 0.0301 |
| Example 5 | | | | | | |
| Example 1 | 38195.72 | 471.61 | 91.45203 | 0.29 | 0.0406 | 0.0297 |
| Example 2 | 39041.61 | 508.647 | 76.77558 | 0.28 | 0.04174 | 0.0292 |
| Example 3 | 95072.03 | 960.840 | 98.17477 | 0.30 | 0.04310 | 0.0301 |
| Example 4 | 61809.22 | 831.791 | 74.30859 | 0.29 | 0.0387 | 0.0287 |
| Example 5 | 48487.42 | 758.812 | 63.89912 | 0.28 | 0.0367 | 0.0279 |

As shown in Table 1, the changes in resistance utilizing the single-walled carbon nanotube conductive material rarely occurred and the orientation ratio was different according to the magnetic field applied.

### Experimental Example 2) Measurement of the Cycle-Life Characteristics

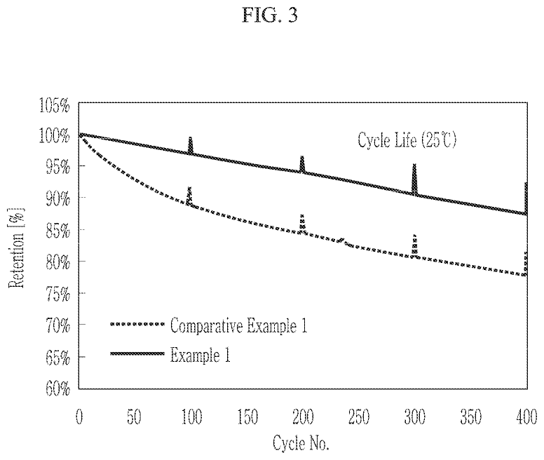

The rechargeable lithium cells according to Examples 1 to 5 and Comparative Examples 1 to 5 were charged and discharged. The charging and the discharging condition was a constant current and constant voltage charged under a 1.0 C, 4.4 V, 0.1 C cut-off condition at 25° C., paused for 5 minutes, constant current discharged under a 1.0 C, 3.0 V cut-off condition, and paused for 5 minutes, which was 1 cycle, and the charging and the discharging was performed for 400 cycles. The capacity retention for the repeated cycles was obtained by calculating discharge capacity at each cycle to 1^{st} discharge. The results are shown in Table 3, and the results of Example 1 and Comparative Example 1 from these results are shown in FIG. 3.

TABLE 3

| | Capacity retention (%) |
|---|---|
| Example 1 | 84.5 |
| Example 2 | 84.2 |
| Example 3 | 84.3 |
| Example 4 | 84 |
| Example 5 | 84.5 |
| Comparative Example 1 | 77.5 |
| Comparative Example 2 | 80.1 |
| Comparative Example 3 | 76.3 |
| Comparative Example 4 | 76.2 |
| Comparative Example 5 | 81.7 |

As shown in Table 3, Examples 1 to 5 utilizing the silicon-based active material and single-walled carbon nanotube conductive material and having an orientation ratio of 50 to 100 exhibited excellent or suitable capacity retention. Whereas, Comparative Example 1 utilizing the ketjen black conductive material, although it had an orientation ratio of 50 to 100, exhibited deteriorated capacity retention. Comparative Examples 3 and 4 having the orientation ratio of 50 to 100, although the single-walled carbon nanotube conductive material was utilized, exhibited deteriorated capacity retention.

Furthermore, Comparative Examples 2 and 5 utilizing the artificial graphite negative active material, although the single-walled carbon nanotube conductive material was utilized and the negative active material had an orientation ratio of 50 to 100, exhibited poor capacity retention.

The terminology used herein is for the purpose of describing particular embodiments only and is not intended to be limiting of the present disclosure. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “About”, “substantially,” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this disclosure is intended to include all higher numerical limitations subsumed therein. Accordingly, Applicant reserves the right to amend this disclosure, including the claims, to expressly recite any sub-range subsumed within the ranges expressly recited herein.

The rechargeable battery, electronic apparatus or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

As used herein, the singular forms “a”, “an” and “the” are intended to include the plural forms as well, unless the context clearly indicates otherwise.

While this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims and equivalents thereof.

What is claimed is:

1. A negative electrode for a rechargeable lithium battery, comprising:
a current collector; and
a negative active material layer on the current collector, the negative active material layer comprising a negative active material and a conductive material,
wherein the negative active material is oriented at a set angle to the current collector,
the negative active material comprises a silicon-based active material,
the conductive material comprises carbon nanotubes, and
the negative electrode has an orientation ratio represented by Equation 1 of about 50 to about 100:
Orientation ratio=I(110)/I(002), and Equation 1
wherein, in Equation 1,
I(110) is a peak intensity at a (110) plane for an x-ray diffraction analysis (XRD) measured by utilizing a CuKα ray, and
I(002) is a peak intensity at a (002) plane for the XRD measured by utilizing the CuKα ray.

2. The negative electrode of claim 1, wherein the orientation ratio is about 54 to about 95.

3. The negative electrode of claim 1, wherein the conductive material is multi-walled carbon nanotubes, single-walled carbon nanotubes, or a combination thereof.

4. The negative electrode of claim 1, wherein the silicon-based active material comprises a silicon-carbon composite comprising crystalline carbon, silicon particles, and an amorphous carbon.

5. The negative electrode of claim 1, wherein the carbon nanotubes have an average length of about 1 μm to about 10 μm.

6. The negative electrode of claim 1, wherein the carbon nanotubes have an average diameter of about 1 nm to about 5 nm.

7. The negative electrode of claim 1, wherein the peak intensity is a peak integral area value.

8. A rechargeable lithium battery, comprising
the negative electrode of claim 1;
a positive electrode; and
an electrolyte.

9. An electronic device comprising the rechargeable lithium battery of claim 8.

10. A method of forming the negative electrode of claim 1, the method comprising:
providing the negative active material layer on the current collector, the negative active material layer comprising the negative active material and the conductive material,
wherein the providing of the negative active material layer comprises:
orienting the negative active material at the set angle to the current collector;
providing the negative active material to comprise the silicon-based active material; and
providing the conductive material to comprise the carbon nanotubes, and
wherein the negative electrode has an orientation ratio represented by Equation 1 of about 50 to about 100:
Orientation ratio=I(110)/I(002), and Equation 1
wherein, in Equation 1,
I(110) is the peak intensity at the (110) plane for the (XRD measured by utilizing the CuKα ray, and
I(002) is the peak intensity at the (002) plane for the XRD measured by utilizing the CuKα ray.
